(19) United States
(12) Patent Application Publication
(10) Pub. No.: US 2019/0077045 A1
(43) Pub. Date: Mar. 14, 2019

(54) PRECARBONATION OF CEMENT MIXES

(71) Applicant: CarbonCure Technologies Inc., Dartmouth (CA)

(72) Inventors: George Sean Monkman, Montreal (CA); Kevin Cail, Sarasota, FL (US); Paul J. Sandberg, Beverly, MA (US); Mark MacDonald, Halifax (CA); Joshua Jeremy Brown, Seattle, WA (US)

(21) Appl. No.: 15/911,573

(22) Filed: Mar. 5, 2018

Related U.S. Application Data
(63) Continuation of application No. PCT/CA2016/051062, filed on Sep. 8, 2016.
(60) Provisional application No. 62/215,481, filed on Sep. 8, 2015.

(51) Int. Cl. B28C 7/02; B28C 5/00; B29B 7/60; B01F 3/04; B28C 7/04; B28C 5/46

(52) U.S. Cl. CPC B28C 7/022; B28C 5/003; B29B 7/603; B01F 2215/0047; B28C 7/0404; B28C 5/462; B01F 3/04531

(57) ABSTRACT

The invention provides methods and compositions for carbonation of a wet cement mix. The wet cement mix may be carbonated prior to addition of aggregates, admixture, SCM, and/or other components to produce a carbonated concrete mix. The methods and compositions may include high shear mixing of a cement or concrete mix, either during or before carbonation.

### CROSS-REFERENCE

This application is a continuation of PCT/CA2016/051062, filed on Sep. 8, 2016, which claims benefit of U.S. Provisional Application No. 62/215,481, filed Sep. 8, 2015, which application is incorporated herein by reference.

### BACKGROUND

Cement mixes, such as concrete mixes, are used in a multitude of compositions and procedures throughout the world. In addition, greenhouse gases such as carbon dioxide are a growing concern worldwide. There is a need for methods and compositions to contact cement mixes with carbon dioxide and for cement mixes containing incorporated carbon dioxide and carbonation products.

### SUMMARY OF THE INVENTION

In one aspect, the invention provides methods.

In certain embodiments, the invention provides a method of carbonating a concrete mix comprising (i) placing cement and water in a first mixer and mixing the materials to produce a cement mixture; (ii) contacting the surface of the mixing cement mixture with carbon dioxide to produce a carbonated cement mixture; (iii) after contacting the mixing cement mixture with carbon dioxide, in a second mixer, adding aggregate to the carbonated cement mixture to produce a carbonated concrete mixture. The carbon dioxide is delivered to the surface of the mixing cement mixture can be delivered in an amount that is a pre-determined dose of carbon dioxide, such as a dose of 0.01-1.0% bwc. In certain embodiments, the first mixer is open to the atmosphere. In certain embodiments, the mixing cement mixture is contacted with carbon dioxide released from one or more openings, wherein the one or more openings are 5-200 cm from the surface of the mixing cement mixture, on average. The first and second mixers can be the same mixer, or they can be different mixers. The method can further comprise transferring the mix to a third mixer, e.g., the drum of a ready-mix truck. In certain embodiments, the ratio of water to cement is less than 0.2 by weight cement. In certain embodiments, the mixing in the first mixer is high shear mixing. In certain embodiments, the carbon dioxide is added to the cement mixture comprises solid carbon dioxide, optionally also including gaseous carbon dioxide. In certain embodiments, the carbon dioxide is added to the cement mixture for a duration of time of 1-30 seconds.

In certain embodiments, the invention provides a method of carbonating a cement mix comprising (i) placing cement and water into a first mixer and mixing the materials to produce a cement mixture; (ii) activating the cement in the cement mixture to produce an activated cement mixture; and (iii) contacting the activated cement mixture with carbon dioxide. The method may further comprise adding aggregate, admixture, supplementary cementitious material, or a combination thereof to the cement mixture. In certain embodiments, the carbon dioxide comprises solid carbon dioxide, and optionally may also include gaseous carbon dioxide. In certain embodiments, the activated cement mixture is transferred to a second mixer that is different from the first mixer, and the carbon dioxide is added to the activated cement mixture in the second mixer. In certain embodiments, the cement mixture is activated by high shear mixing. In certain embodiments, the first mixer is a high shear mixer.

In another aspect, the invention provides apparatus.

In certain embodiments, the invention provides an apparatus for carbonating a cement mix comprising (i) a first mixer configured to mix a hydraulic cement and water to produce a wet cement mix, and to deliver carbon dioxide to the mixing wet cement mix to produce a carbonated cement mix; (ii) a second mixer different from the first mixer configured to receive the carbonated wet cement mix from the first mix and to further add an aggregate to the cement mix to produce a carbonated concrete mix. The apparatus may further comprise a third mixer different from the first and second mixers configured to receive the carbonated concrete mix from the second mixer. The third mixer can be a transportable mixer to transport the concrete mix to a location remote from the first and second mixers, which are fixed or relatively fixed. In certain embodiments, the first mixer is a high shear mixer.

In certain embodiments the invention provides an apparatus for carbonating a wet concrete mix comprising (i) a first mixer that is a high shear mixer configured to receive cement and water and mix the cement and water in a high shear manner to produce an activated cement mix; (ii) a second mixer configured to deliver a dose of carbon dioxide to the activated cement mix to produce a carbonated cement mix. The first mixer and the second mixer can be the same mixer. In certain embodiments, the carbon dioxide is delivered during the high shear mixing. In certain embodiments, the first mixer and the second mixer are different mixers and the apparatus further comprises a system for transferring the activated cement mix from the first mixer to the second mixer. In certain embodiments, the apparatus further comprises a third mixer configured to receive the carbonated cement mix from the second mixer.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### DETAILED DESCRIPTION OF THE INVENTION

The methods and compositions of the invention are useful in the carbonation of wet cement mixes, e.g., hydraulic cement mixes such as Portland cement mixes. In general, the methods and compositions incorporate one or both of: (1) pre-carbonation of a wet cement mix before addition of aggregates, admixtures, and the like; and/or (2) activation of a wet cement or concrete mix, for example, by high shear mixing, either before or during carbonation, or both. In certain embodiments, apparatus of the invention provide a first mixer and a second mixer, which in some instances can be the same mixer. In certain embodiments, a wet cement mix is carbonated in the first mixer to produce a carbonated cement mix and then aggregate and other optional components such as admixture are added in the second mixer to produce a carbonated concrete mix. The carbonated concrete mix may then be transferred to a holder, such as a hopper (e.g., in a precast operation), or to a third mixer, such as a transportable mixer (e.g., the drum of a ready-mix truck, in a ready-mix operation). The terms “cement” and “concrete” are as described in U.S. Pat. No. 9,108,883.

Exemplary operations in which the methods and apparatus of the invention are useful is in a precast or ready-mix operation that uses a central batching system (also known as a wet batch or pre-mix plant) wherein concrete is made in a high throughput mixer (e.g., 30 to 180 s per mix), then the finished mix is deposited into a hopper or mold (precast plant) or a ready-mix truck (ready-mix plant). In the latter case, the truck may then leave the site without any further substantial delay. If it is desired to carbonate the concrete mix in these operations, a post-mixing application of CO₂, for example in the drum of the ready-mix truck, would interrupt the process. Thus, the invention provides the means to carbonate concrete mixes produced in such operations without interrupting the process or substantially lengthening the time per batch, allowing a carbonated concrete mix to be produced but otherwise leaving the operation intact. CO₂ addition at an appropriate point in the mixing process can result in performance gains and performance gains can be realized through small CO₂ uptakes. The invention provides an alternative to, e.g., adding carbon dioxide in the drum of the ready-mix truck, which in the case of a central batching ready-mix operation could well lead to unacceptable delays in the operation.

In certain cases, cement and water are mixed in a first mixer and carbonated in that mixer by the addition of carbon dioxide to the wet mix to produce a carbonated wet cement mix; this can be done in a batch or continuous process. If one or more supplementary cementitious materials (SCMs), such as fly ash, slag, pozzolans, or the like, are to be used in the final concrete, they may be added in the first mixer or subsequently, or a combination thereof. One or more admixtures may also be added in the first mixer. The first mixer can be open to the atmosphere or sealed; in the latter case, the mixer may be pressurized to above atmospheric pressure in certain embodiments. The carbonated wet cement mix is then added to a second, different, mixer, where the remaining components of the concrete mix, e.g., aggregates, admixture, and the like, are added and the final carbonated concrete mix is produced. Alternatively, the additional components of the concrete mix may be added to the first mixer, and there is only one mixer involved in the production of the carbonated concrete mix. In certain embodiments, the carbonated wet cement mix may be temporarily stored in a storage container, e.g., hopper, before being added to the second mixer. In a central batching ready-mix operation, a separate mixer can be added to carbonate the wet cement mix. In some central batching ready-mix operations a separate mixer (“premixer”) for producing a mixed wet cement mix is already used and the carbonation of the wet cement mix can involve a simple retrofit to provide a source of carbon dioxide, conduit to carry the carbon dioxide to the cement mixer, and appropriately situated opening in the mixer to deliver the carbon dioxide to the mixing cement mix, e.g., to the surface of the mixing cement mix. For a description of premixers, see, e.g., Gary R Mass (1989) Premixed Cement Paste, Concrete International, 11(11):82-85. Similar considerations apply to a precast operation. The premixer can be, e.g., a vortex mixer, a paddle-style mixer, or a screw-type mixer, such as the Hydromix 3000 (Sherwood, Oreg.). Any other suitable premixer may be used. See also U.S. Pat. No. 5,352,035 and U.S. Patent Application Nos. 20050219939 and 20110249527.

In order to facilitate carbonation in the first mixer, the cement mix can be prepared at a relatively low water/cement (w/c) ratio, such as less than or equal to 0.2, 0.18, 0.16, 0.15, 0.14, 0.13, 0.12, 0.11, 0.10, 0.08, 0.06, or 0.05. In certain embodiments the w/c ratio is less than or equal to 0.15. In certain embodiments, the w/c ratio is 0.01-0.2, or 0.01-0.18, or 0.01-0.15, or 0.01-0.13, or 0.01-0.10, or 0.01-0.05, or 0.05-0.2, or 0.05-0.18, or 0.05-0.15, or 0.05-0.13, or 0.05-0.10. Additional water is then added, either in the first mixer or in a subsequent mixer, to bring the final concrete mix up to the desired w/c ratio. Some or all of the mix water, either in the first mixer or in the second mixer, or both, can be carbonated to further enhance carbonation of the cement mix and/or concrete mix. See PCT Application No. PCT/CA 2014/050611, as well as U.S. Pat. No. 9,108,803.

In addition, or alternatively, the first mixer can be a mixer configured for high energy mixing of the wet cement mix, such as a high shear mixer. High energy (high shear) mixers are known in the art and are currently used in premixers in some ready-mix operations. See, e.g., http://www.nrmca.org/aboutconcrete/howproduced.asp, which describes a slurry mixer: “The slurry mixer is a relative newcomer to concrete mixing technology. It can be added onto a dry-batch plant and works by mixing cement and water that is then loaded as slurry into a truck mixer along with the aggregates. It is reported to benefit from high-energy mixing. Another advantage is that the slurry mixer reduces the amount of cement dust that escapes into the air.” Thus in certain embodiments the first mixer is a slurry mixer, such as a high shear slurry mixer. “High shear” is used herein as understood in the art. In certain embodiments a mixer is used having an average shear rate over the course of mixing the cement mix of greater than 50, 100, 200, 300, 400, 500, 600, 700, 800, 900, 1000, 1200, 1500, 2000, 3000, or 4000 sec⁻¹. Other methods of activating a cement can also be used. A jet mill is one example. See also U.S. Patent Publication No. 20130305963 for further description of methods and apparatus for activating a cement mix. Without being bound by theory, it is thought that a mechanically activated wet paste allows the ionic activity of the paste to be suitable for CO₂ addition within short production cycles. The shearing action improves the hydration of the cement. Carbonate reaction products formed on a moist powder (rather than in a fluid mix) are likely to rest on the particle surface and possibly hamper later hydration of the cement by physically closing off reaction site; the shearing action is likely to dislodge or otherwise modify the carbonate reaction products on the cement surface and thereby improve the later hydration. In the case of high shear mixing, the w/c ratio can be a low ratio as described above, or it can be a more normal ratio for a wet cast operation, e.g., 0.4. Other w/c ratios are as described in U.S. Pat. No. 9,108,803.

In certain embodiments, activation such as by high shear mixing is used for the entire concrete mix, i.e., cement, water, aggregates, and, optionally, admixture and/or other components such as SCM, during carbonation. In these embodiments, no separate mixing of the cement and water is used, rather, the feature that promotes carbonation is the high shear mixing. Carbonation is achieved by addition of carbon dioxide during the mixing.

The carbon dioxide can be added to the mixing wet cement mix (or in certain embodiments, wet concrete mix) in any suitable form, such as a gas, solid, liquid, or supercritical. In certain embodiments, the carbon dioxide is added as a gas. In certain embodiments, the carbon dioxide is added as a solid (e.g., dry ice). In certain embodiments, the carbon dioxide is added as a mixture of gas and solid, such as produced by exposing pressurized liquid carbon dioxide to a sufficient pressure drop to cause it to become a gas/solid mixture. See PCT Application No. PCT/CA 2014/050611 as well as U.S. Patent Application No. 20140216303 for further description of systems and methods for adding a gas/solid carbon dioxide mixture to a concrete or cement mix. The carbon dioxide can be added to the surface of the mixing cement or concrete mix, or beneath the surface.

Because many operations utilize very short mixing times, the duration of carbon dioxide addition may in some embodiments be very short, e.g., as short as 5 or 10 seconds. Generally, the duration will be the maximum duration allowed by the operation, though this is not necessary if lower levels of carbonation are used. In certain embodiments, the duration of carbon dioxide addition is no more than 120, 90, 80, 70, 60, 50, 40, 30, 20, 10, or 5 seconds. In certain embodiments, the duration of carbon dioxide addition to the wet cement mix is 1-180, or 1-150, or 1-120, or 1-90, or 1-80, or 1-70, or 1-60, or 1-50, or 1-40, or 1-30, or 1-20, or 1-10, or 1-5 seconds; or 5-180, or 5-150, or 5-120, or 5-90, or 5-80, or 5-70, or 5-60, or 5-50, or 5-40, or 5-30, or 5-20, or 5-10 seconds.

The timing of addition of carbon dioxide can be any suitable timing. For example, carbon dioxide can be added to the cement mix before, during, or after the addition of water to the mix. In certain embodiments, such as when a wet cement mix that has been subjected to high shear mixing is used, the carbon dioxide can be added to the wet cement mix considerably later than the water addition, for example, at least 5, 10, 15, 20, 25, 30, 45, 60, 75, 90, 105, 120, 135, 150, 165, or 180 seconds after the first water addition to the dry cement powder.

The dose of carbon dioxide added in the carbonation step may be any suitable dose, for example, 0.01-8%, or 0.01-5%, or 0.01-3%, or 0.01-2%, or 0.01-1.5% bwc. In certain embodiments, a relatively low level of carbonation is used, e.g., a level of carbonation below 1%, 0.8%, 0.7%, 0.6%, 0.5%, 0.4%, 0.3%, 0.2%, or 0.1% bwc. For example, it has been found that certain properties, e.g., early strength development and set, may be accelerated in cement mixes, such as hydraulic cement mixes, that are exposed to relatively low levels of carbon dioxide during mixing. It is possible that, in some cases, the exposure may be low enough that the degree of carbonation is not measurably above that of a similar cement mix that has not been exposed to carbon dioxide; nonetheless, the exposure may lead to the desired enhanced properties. Thus, in certain embodiments, the mixing cement mix is exposed to a certain relatively low dose of carbon dioxide (in some cases regardless of final carbonation value); in this sense, carbon dioxide is used like an admixture whose final concentration in the cement mix is not important but rather its effects on the properties of the mix. In certain embodiments, the mix may be exposed to a dose of carbon dioxide of not more than 5%, 4%, 3%, 2%, 1.5%, 1.2%, 1%, 0.8%, 0.7%, 0.6%, 0.5%, 0.4%, 0.3%, 0.2%, 0.1%, or 0.05% bwc and/or at least 0.01, 0.05, 0.1, 0.2, 0.3, 0.4, 0.5, 0.6, 0.7, 0.8, 0.9, 1.0, 1.2, 1.5, 2, 3, or 4% bwc, such as a dose of 0.01-1.5%, 0.01-1.2%, 0.01-1%, 0.01-0.8%, 0.01-0.6%, 0.01-0.5%, 0.01-0.4%, 0.01-0.3%, 0.01-0.2%, or 0.01-0.1% bwc, or a dose of 0.02-1.5%, 0.02-1.2%, 0.02-1%, 0.02-0.8%, 0.02-0.6%, 0.02-0.5%, 0.02-0.4%, 0.02-0.3%, 0.02-0.2%, or 0.02-0.1% bwc, or a dose of 0.04-1.5%, 0.04-1.2%, 0.04-1%, 0.04-0.8%, 0.04-0.6%, 0.04-0.5%, 0.04-0.4%, 0.04-0.3%, 0.04-0.2%, or 0.04-0.1% bwc, or a dose of 0.06-1.5%, 0.06-1.2%, 0.06-1%, 0.06-0.8%, 0.06-0.6%, 0.06-0.5%, 0.06-0.4%, 0.06-0.3%, 0.06-0.2%, or 0.06-0.1% bwc, or a dose of 0.1-1.5%, 0.1-1.2%, 0.1-1%, 0.1-0.8%, 0.1-0.6%, 0.1-0.5%, 0.1-0.4%, 0.1-0.3%, or 0.1-0.2% bwc.

In certain embodiments the invention provides a method of producing a carbonated concrete mix for use in a ready-mix operation in which a carbonated wet cement mix is produced in a first mixer and then added to a different second mixer, where aggregates and, optionally, admixture and/or other components are added to produce a carbonated concrete mix. The carbonated wet cement mix may be transferred to a temporary storage container, e.g., a hopper, before addition to the second mixer. The first mixer may be open to the atmosphere or closed; in certain embodiments, the first mixer is open. The carbon dioxide may be added as a liquid, gas or as a solid; in certain embodiments the carbon dioxide is added as a mixture of gaseous and solid carbon dioxide, e.g., as produced by exposing liquid carbon dioxide to a sufficient pressure drop that it converts to solid and gaseous carbon dioxide. In certain embodiments, the carbon dioxide is applied to the surface of the mixing cement mix in the first mixer, e.g., via a conduit, such as a conduit whose opening is 1-200, 1-100, 1-50, 5-200, 5-100, or 5-50 cm from the surface of the mixing cement, on average. The second mixer can be the drum of a ready-mix truck. The second mixer can be a central batch mixer, and the final carbonated concrete mix produced in the central batch mixer can be transferred to a third mixer, e.g., the drum of a ready-mix truck. The first mixer may be a retrofitted mixer, or it may be a mixer that is already part of the ready-mix operation. The dose, timing of addition, duration of addition, and form of carbon dioxide added to the cement mix in the first mixer may be any of those described herein. Additional carbon dioxide may be added, e.g., in the second or third mixer, or in the mix water, etc. In certain embodiments the first mixer is a continuous mixer. In certain embodiments, the first mixer is a batch mixer. The first mixer may be a high shear mixer. In certain embodiments, the w/c ratio in the first mixer is no more than 0.2. In certain embodiments, the w/c ratio in the first mixer is no more than 0.15. Other w/c ratios are as described herein. The first mixer may be open to the atmosphere or it may be sealed; in the latter case, the first mixer may be pressurized to greater than atmospheric pressure.

In certain embodiments the invention provides a method of producing a carbonated concrete mix for use in a precast operation in which a carbonated wet cement mix is produced in a first mixer and then added to a different second mixer, where aggregates and, optionally, admixture and/or other components are added to produce a carbonated concrete mix. The carbonated wet cement mix may be transferred to a temporary storage container, e.g., a hopper, before addition to the second mixer. The first mixer may be open to the atmosphere or closed; in certain embodiments, the first mixer is open. The carbon dioxide may be added as a liquid, gas or as a solid; in certain embodiments the carbon dioxide is added as a mixture of gaseous and solid carbon dioxide, e.g., as produced by exposing liquid carbon dioxide to a sufficient pressure drop that it converts to solid and gaseous carbon dioxide. In certain embodiments, the carbon dioxide is applied to the surface of the mixing cement mix in the first mixer, e.g., via a conduit, such as a conduit whose opening is 1-200, 1-100, 1-50, 5-200, 5-100, or 5-50 cm from the surface of the mixing cement, on average. The second mixer can be a central batch mixer, and the final carbonated concrete mix produced in the central batch mixer can be transferred to a container, such as a hopper, for transfer to a mold to produce a precast concrete object. The first mixer may be a retrofitted mixer, or it may be a mixer that is already part of the precast operation. The dose, timing of addition, duration of addition, and form of carbon dioxide added to the cement mix in the first mixer may be any of those described herein. Additional carbon dioxide may be added, e.g., in the second mixer, or in the mix water, etc. In certain embodiments the first mixer is a continuous mixer. In certain embodiments, the first mixer is a batch mixer. The first mixer may be a high shear mixer. In certain embodiments, the w/c ratio in the first mixer is no more than 0.2. In certain embodiments, the w/c ratio in the first mixer is no more than 0.15. Other w/c ratios are as described herein. The first mixer may be open to the atmosphere or it may be sealed; in the latter case, the first mixer may be pressurized to greater than atmospheric pressure.

In certain embodiments the invention provides a method of carbonating a cement mix by addition of carbon dioxide to a wet cement mix, either while the mix is subject to high shear mixing, or after the mix has been subject to high shear mixing, or both. The cement mix may be just a cement-water mix to which one or more additional concrete components, such as aggregates, admixtures, and/or SCM are added after the addition of carbon dioxide, or it may contain the one or more additional concrete components during the carbonation. The mixer may be open to the atmosphere or closed; in certain embodiments, the mixer is open. The carbon dioxide may be added as a liquid, gas or as a solid; in certain embodiments the carbon dioxide is added as a mixture of gaseous and solid carbon dioxide, e.g., as produced by exposing liquid carbon dioxide to a sufficient pressure drop that it converts to solid and gaseous carbon dioxide. In certain embodiments, the carbon dioxide is applied to the surface of the mixing cement mix in the first mixer, e.g., via a conduit, such as a conduit whose opening is 1-200, 1-100, 1-50, 5-200, 5-100, or 5-50 cm from the surface of the mixing cement, on average.

In certain embodiments the invention provides an apparatus for carbonating a cement mix comprising a first mixer configured to expose a wet cement mix to carbon dioxide during mixing to produce a carbonated cement mix, a system for transferring the carbonated wet cement mix thus produced to a second, different, mixer, where the second mixer is configured to add to the carbonated wet cement mix additional components of concrete, such as aggregates, admixtures, SCM, additional water, and the like, to produce a carbonated concrete mix. The mixer may be open to the atmosphere or closed; in certain embodiments, the mixer is open. The carbon dioxide may be added as a liquid, gas or as a solid; in certain embodiments the carbon dioxide is added as a mixture of gaseous and solid carbon dioxide, e.g., as produced by exposing liquid carbon dioxide to a sufficient pressure drop that it converts to solid and gaseous carbon dioxide; thus, the apparatus may comprise an injector at the end of the conduit that is configured to convert liquid carbon dioxide to solid and gaseous carbon dioxide upon exiting the injector. In certain embodiments, the carbon dioxide is applied to the surface of the mixing cement mix in the first mixer, e.g., via the conduit, such that the conduit has an opening that is placed to be 1-200, 1-100, 1-50, 5-200, 5-100, or 5-50 cm from the surface of the mixing cement, on average. In certain embodiments, the first mixer is a high shear mixer. The apparatus can include a carbon dioxide storage container, a conduit for carrying carbon dioxide from the storage container to the first mixer, and a connection between the conduit and the first mixer for directing the carbon dioxide to the cement mix during mixing. In embodiments in which solid and gaseous carbon dioxide are applied to the mixing cement, the carbon dioxide container may be a container for liquid carbon dioxide and the conduit comprises materials that are able to withstand the temperature of the liquid carbon dioxide carried therein; the conduit ends in an injector, as described herein. A further conduit may extend from the injector to the desired position relative to the mixing concrete, in order to direct the gaseous and solid carbon dioxide to the desired location. In certain embodiments the apparatus comprises a third mixer, different from the first two mixers, and a system for transferring the carbonated concrete mix from the second mixer to the third mixer. There may be one or more holding units for holding the carbonated cement mix and/or the carbonated concrete mix before their transfer to the appropriate mixer. In certain embodiments, e.g., precast operations, the apparatus may include a mold to which the carbonated concrete mix is transferred, and, optionally, a holding unit for holding the carbonated concrete mix before transfer to the mold. The apparatus can include a controller for controlling one or more aspects of the operation of the apparatus, such as a computer. The controller may comprise one or more sensors to sense one or more of time of flow of carbon dioxide to the cement mix, mass of carbon dioxide flowed to the cement mix, position of the conduit for carbon dioxide delivery; a processor operably connected to the one or more sensors that processes the information from the sensor(s); and one or more actuators, operably connected to the processor, such as one or more valves, e.g., in a conduit that transports the carbon dioxide, to modulate the flow of carbon dioxide according to a signal from the processor, e.g., when the processor determines that a predetermined amount of carbon dioxide has been delivered. The predetermined amount may be, e.g., any amount as described herein.

In all embodiments, the final mix may further include supplementary cementitious material. Any suitable SCM may be used, such as fly ash, blast furnace slag, pozzolan, and the like. The SCM may be used as a cement replacement and may be used in any suitable amount, such as 1-50, 1-40, 1-30, 1-20, 1-10, 1-5, 2-50, 2-40, 2-30, 2-20, 2-10, 2-5, 5-50, 5-40, 5-30, 5-20, or 5-10% by weight cement (bwc). In certain embodiments the SCM is added along with the cement and water and is exposed to carbon dioxide along with the cement; in certain embodiments, the SCM is added after exposure of the cement to carbon dioxide.

In certain embodiments the invention provides an apparatus for carbonating a cement mix comprising a high shear mixer configured to mix a cement mix in a high shear manner while exposing the cement mix to carbon dioxide. Thus the apparatus may include a carbon dioxide storage container, a conduit for carrying carbon dioxide from the storage container to the mixer, and a connection between the conduit and the mixer for directing the carbon dioxide to the cement mix during mixing.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention.

1. A method of carbonating a concrete mix comprising
(i) placing cement and water in a first mixer and mixing the materials to produce a cement mixture;
(ii) contacting the surface of the mixing cement mixture with carbon dioxide to produce a carbonated cement mixture;
(iii) after contacting the mixing cement mixture with carbon dioxide, in a second mixer, adding aggregate to the carbonated cement mixture to produce a carbonated concrete mixture.

2. The method of claim 1 wherein the carbon dioxide is delivered to the surface of the mixing cement mixture in an amount that is a pre-determined dose of carbon dioxide.

3. The method of claim 2 wherein the predetermined dose of carbon dioxide is a dose of 0.01-3% bwc.

4. The method of claim 1 wherein the first mixer is open to the atmosphere.

5. (canceled)

6. (canceled)

7. The method of claim 1 wherein the first and second mixers are different mixers.

8. The method of claim 7 further comprising transferring the carbonated cement mix to a third mixer.

9. The method of claim 1 wherein the ratio of water to cement is less than 0.2 by weight cement.

10. The method of claim 1 wherein the mixing in the first mixer is high shear mixing.

11. The method of claim 1 wherein the carbon dioxide is added to the cement mixture comprises solid carbon dioxide.

12. (canceled)

13. The method of claim 1 wherein the carbon dioxide is added to the cement mixture for a duration of time of less than 30 seconds.

14. A method of carbonating a cement mix comprising
(i) placing cement and water into a first mixer and mixing the materials to produce a cement mixture;
(ii) activating the cement in the cement mixture to produce an activated cement mixture;
(iii) contacting the activated cement mixture with carbon dioxide.

15. The method of claim 14 further comprising adding aggregate, admixture, supplementary cementitious material, or a combination thereof to the cement mixture.

16. The method of claim 14 wherein the carbon dioxide comprises solid carbon dioxide.

17. (canceled)

18. The method of claim 14 wherein the activated cement mixture is transferred to a second mixer that is different from the first mixer, and the carbon dioxide is added to the activated cement mixture in the second mixer.

19. The method of claim 14 wherein the cement mixture is activated by high shear mixing.

20. The method of claim 19 wherein the first mixer is a high shear mixer.

21. An apparatus for carbonating a cement mix comprising
(i) a first mixer configured to mix a hydraulic cement and water to produce a wet cement mix, and to deliver carbon dioxide to the mixing wet cement mix to produce a carbonated cement mix;
(ii) a second mixer different from the first mixer configured to receive the carbonated wet cement mix from the first mix and to further add an aggregate to the cement mix to produce a carbonated concrete mix.

22. The apparatus of claim 21 further comprising a third mixer different from the first and second mixers configured to receive the carbonated concrete mix from the second mixer.

23. The apparatus of claim 21 wherein the third mixer is a transportable mixer to transport the concrete mix to a location remote from the first and second mixers, which are fixed or relatively fixed.

24. The apparatus of claim 21 wherein the first mixer is a high shear mixer.

25. An apparatus for carbonating a wet concrete mix comprising
(i) a first mixer that is a high shear mixer configured to receive cement and water and mix the cement and water in a high shear manner to produce an activated cement mix;
(ii) a second mixer configured to deliver a dose of carbon dioxide to the activated cement mix to produce a carbonated cement mix.

26. The apparatus of claim 25 wherein the first mixer and the second mixer are the same mixer.

27. The apparatus of claim 26 wherein the carbon dioxide is delivered during the high shear mixing.

28. The apparatus of claim 26 wherein the first mixer and the second mixer are different mixers and the apparatus further comprises a system for transferring the activated cement mix from the first mixer to the second mixer.

29. The apparatus of claim 25 further comprising a third mixer configured to receive the carbonated cement mix from the second mixer.

30. The method of claim 10 wherein the mixer has an average shear rate over the course of mixing the cement mix of greater than 500 sec⁻¹.

31. The method of claim 1 wherein the carbon dioxide is added to the cement mix at least 5 seconds after the first water addition to the dry cement powder.

32. The method of claim 14 wherein the carbon dioxide is added to the cement mix at least 5 seconds after the first water addition to the dry cement powder.

33. The apparatus of claim 21 further comprising a carbon dioxide container operably connected to a first conduit that terminates in an injector and a second conduit, operably connected to the first conduit and positioned to direct the carbon dioxide into the first mixer.
